(19) United States
(12) Patent Application Publication
(10) Pub. No.: US 2025/0218624 A1
(43) Pub. Date: Jul. 3, 2025

(54) A communication assembly for an electrical connection system

(71) Applicant: CONNEC LIMITED, Queensland (AU)

(72) Inventors: Stephen WILLIAMS, Queensland (AU); Dylan TOTH, Queensland (AU)

(73) Assignee: CONNEC LIMITED, Queensland (AU)

(21) Appl. No.: 18/850,644

(22) PCT Filed: Apr. 28, 2022
(86) PCT No.: PCT/AU2022/050392

§ 371 Date: Sep. 25, 2024

(30) Foreign Application Priority Data
Mar. 25, 2022 (AU) 2022900762

(51) Int. Cl. H01B 11/22; G02B 6/38; H01R 13/53

(52) U.S. Cl. CPC H01B 11/22; G02B 6/3813; G02B 6/3825; H01R 13/53

(57) ABSTRACT

A communication assembly (100, 200, 300) configured for use in a connection system suitable for transmission of power with voltage levels greater than or equal to 1 KV is provided. The communications assembly comprises an outer housing portion (102, 202, 302) configured to be mounted at a mounting location of the connection system, and an inner portion (104, 204, 304) positioned in the outer housing portion, the inner portion comprising a connection end (106, 206, 306) and being configured to provide at least one path for transmission of a communications signal, the connection end comprising at least one fibre optic connector (110, 210, 310). A communication system (700) and a connection component (900) are also provided, each configured for use in a connection system suitable for transmission of power with voltage levels greater than or equal to 1 kV.

### FIELD OF THE INVENTION

The present invention relates to a communication assembly for a connection system suitable for transmission of power with voltage levels greater than or equal to 1 kV, and to a connection system comprising the communication assembly.

### BACKGROUND OF THE INVENTION

Reliable electrical connections are crucial in high power applications, such as powering of heavy electrical machinery often used in the mining or petroleum industry. In these applications the electrical cables transmit high currents at voltages of one or more kilovolts (kV).

Electrical connection systems for the transmission of high currents at voltages of one or more kV may be referred to as high voltage coupler systems. The environment of such high voltage coupler systems is a hazardous one and workers in the field are at a high risk of injury.

Typical electrical connection systems used in the art include electrical connectors having a plurality of pins or sockets, each being connected to a respective core of an electrical cable. Depending on the specific application, the connectors must comply with specific requirements or standards. In some instances, the compliance of the connectors with the relevant standards is examined by a certifying body. In an explosive environment, for example, particular precaution must be taken, and a flame path may be required between connectors to reduce likelihood of explosions. The flame path typically is formed between a plug and a receptacle by positioning a cylindrical surface that surrounds contacts and/or electrical leads of the plug inside a respective surface of a receptacle.

Further, to enable transmission of data, electrical connection systems may be equipped with internal communication assemblies adapted for data transmission via metallic cables such as copper (Cu) cables. Transmitted data may include useful information for end-users working in the surroundings of high voltage coupler systems. Alignment and secure connection of such communication assemblies during and after mating of components of the electrical connection system (for example mating between a plug and a receptacle of the electrical connection system) are critical for reliable data transmission.

Further improvement is needed to provide a safe environment for workers or other persons present in the surroundings of high voltage connection systems.

### SUMMARY

In accordance with a first aspect, the present invention provides a communication assembly configured for use in a connection system suitable for transmission of power with voltage levels greater than or equal to 1 kV, the communications assembly comprising:
an outer housing portion configured to be mounted at a mounting location of the connection system; and
an inner portion positioned in the outer housing portion, the inner portion comprising a connection end and being configured to provide at least one path for transmission of a communications signal, the connection end comprising at least one fibre optic connector.

The at least one fibre optic connector may be adapted for coupling to a respective mating fibre optic connector of another communication assembly to create a connection for transmission of a communications signal.

The connection end may comprise at least two fibre optic connectors.

In one embodiment, the outer housing portion and the inner portion have a substantially cylindrical shape.

In one embodiment, the outer housing portion comprises an insulating material.

The communication assembly may further comprise a resilient element configured to be biased to secure and maintain engagement of mating fibre optic connectors when the communication assembly is coupled to another communication assembly.

In one embodiment, the resilient element is configured such that, when biased, it applies constant force to a rear end of the communication assembly.

The resilient element may be a spring having a spring rate within the range 5 kgf to 10 kgf.

In one embodiment, the inner portion comprises two opposite connection ends, each connection end comprising at least one fibre optic connector. Each connection end may comprise at least two fibre optic connectors.

The communication assembly may further comprise an alignment system for facilitating alignment and coupling of each fibre connector with a respective mating fibre optic connector of another mating communication assembly.

In one embodiment, the alignment system comprises one or more guiding portions configured to guide the alignment and coupling of the communication assembly with another mating communication assembly.

When the communication assembly is coupled to the other mating communication assembly, the one or more guiding portions may be configured to interlock with one or more mating guiding portions of the other mating communication assembly in a manner such that a rotational displacement of the communication assembly and the other mating communication assembly to each other is allowed.

In one embodiment, the one or more guiding portions extend along at least a portion of a length of the communication assembly.

The one or more guiding portions may comprise one or more guiding portions located at the connection end.

In one embodiment, the one or more guiding portions comprise one or more protrusions and/or one or more mating grooves, the protrusion and mating grooves extending longitudinally along at least a portion of a length of the communication assembly.

The one or more guiding portions may comprise rounded edges.

The one or more guiding portions may be configured such that, when the communication assembly is coupled to the other mating communication assembly, the one or more guiding portions interlock with the one or more mating guiding portions of the other mating communication assembly prior to respective opposite mating fibre optic connectors being coupled and connected to each other.

In one embodiment, the one or more guiding portions comprise a shroud portion located at the connection end of the communication assembly.

The inner portion may be fixed in a longitudinal direction relative to the outer housing portion. In this embodiment, the communication assembly may comprise a fastening element configured to restrict linear movement of the inner portion relative to the outer housing portion.

The alignment system may comprise at least one locating portion at the outer surface of the outer housing portion, the at least one locating portion being configured to couple to a respective locating portion of a connection component of the connection system, whereby the communication assembly is substantially secured to the connection component when the communication assembly is mounted at a location of the connection component.

The alignment system may be configured such that, when the communication assembly is coupled to another communication assembly, a maximised angle of collinearity tolerance is allowed between the mated communication assemblies.

The at least one path and at least one fibre optic connector may be configured for use with any one of a single-mode optical fibre element or a multi-mode optical fibre element.

In accordance with a second aspect of the present invention, there is provided a communication system configured for use in a connection system suitable for transmission of power with voltage levels greater than or equal to 1 kV, the communication system comprising a pair of communication assemblies that are configured to provide at least one path for transmission of a communications signal and such that they can be coupled to each other to make a connection for transmission of a communications signal.

The pair of communication assemblies may comprise a male communication assembly and a female communication assembly, the male communication assembly and the female communication assembly being configured for mounting at a respective location of respective first and second components of the connection system.

Each of the male communication assembly and the female communication assembly may comprise:
an outer housing portion configured to be mounted at a mounting location of a respective component of the connection system; and
an inner portion positioned in the outer housing portion, the inner portion comprising a connection end and being configured to provide at least one path for transmission of a communications signal, the connection end comprising at least one fibre optic connector, each fibre optic connector of the male communication assembly being adapted for coupling to a respective mating fibre optic connector of the female communication assembly to create a connection for transmission of a communication signal.

The outer housing portion and the inner portion may have a substantially cylindrical shape.

In one embodiment, the communication system comprises an alignment system for facilitating alignment and coupling of respective opposite mating fibre optic connectors when the pair of communication assemblies are coupled to each other.

The alignment system may comprise one or more guiding portions configured to guide the alignment and coupling of the pair of communication assemblies.

The one or more guiding portions may be configured to guide the alignment and coupling of the pair of communication assemblies in a manner such that respective opposite mating fibre optic connectors are aligned prior to being coupled and connected when the pair of communication assemblies are coupled to each other.

Each of the male and female communication assemblies may comprise one or more respective male and female guiding portions. The male guiding portions and respective female guiding portions may be configured in a manner such that a rotational displacement of the male and female communication assemblies relative to each other around a longitudinal axis of the communication assemblies is allowed.

In one embodiment, the one or more guiding portions extend along at least a portion of a length of the communication assembly.

In one embodiment, the one or more guiding portions comprise one or more protrusions and one or more respective mating grooves, the protrusions and mating grooves extending longitudinally along at least a portion of a length of the communication assembly.

In one embodiment, when the male and female communication assemblies are coupled, the one or more male guiding portions interlock with the one or more female guiding portions prior to respective male and female fibre optic connectors being coupled and connected to each other.

In one embodiment, the one or more guiding portions comprise rounded edges.

In one embodiment, the one or more guiding portions comprise a shroud portion located at the connection end of at least one of the male and female communication assemblies.

In one embodiment, the inner portion of at least one of the communication assemblies is fixed in a longitudinal direction relative to the outer housing portion. In this embodiment, the at least one of the communication assemblies may comprise a fastening element configured to restrict linear movement of the inner portion relative to the outer housing portion.

At least one of the communication assemblies may comprise a resilient element configured to be biased to secure and maintain engagement of the male and female fibre optic connectors when the pair of communication assemblies are coupled to each other. The resilient element may be configured such that, when biased, it applies constant force to a rear end of the at least one of the communication assemblies. The resilient element may be a spring having a spring rate within the range 5 kgf to 10 kgf.

The alignment system may be configured such that, when the male and female communication assemblies are coupled, a maximised angle of collinearity tolerance is allowed between the mated communication assemblies.

In one embodiment, the communication assemblies form isolated flameproof chambers when mated to each other. A flame path may be provided within the communication system. The communication assemblies, when mated to each other, may define front and rear flame paths.

The inner portion of at least one of the pair of communication assemblies may comprise two opposite connection ends, each connection end comprising at least one fibre optic connector. Each connection end may comprise at least two fibre optic connectors.

In one embodiment, the outer housing portion comprises an insulating material.

The at least one path and at least one fibre optic connector may be configured for use with any one of a single-mode optical fibre element or a multi-mode optical fibre element.

In one embodiment, the first component is a plug arranged for engagement, mechanically and electrically coupling with the second component.

In one embodiment, the second component may be one of a receptacle and a back-to-back receptacle.

In another embodiment, the first component may be a plug coupler. The second component may be an electrical adaptor.

In accordance with a third aspect of the present invention, there is provided a connection component configured for use in a connection system suitable for transmission of power with voltage levels greater than or equal to 1 kV, the connection component comprising:
at least one electrical assembly for coupling to an electrical cable, the at least one electrical assembly being configured to provide a path for transmission of the power; and
at least one communication assembly in accordance with the first aspect.

The connection component may comprise at least two communication assemblies, each communication assembly being in accordance with the first aspect.

### BRIEF DESCRIPTION OF THE DRAWINGS

Notwithstanding any other forms which may fall within the scope of the disclosure as set forth in the Summary, specific embodiments will now be described, by way of example only, with reference to the accompanying drawings in which:

FIG. 1a is a perspective front view of a communication assembly in accordance with an embodiment;

FIG. 1b is a perspective rear view of the communication assembly of FIG. 1a;

FIG. 1c is a cross-sectional view in a longitudinal direction of the communication assembly of FIG. 1a;

FIG. 1d is a front view of the communication assembly of FIG. 1a;

FIG. 1e is a rear view of the communication assembly of FIG. 1a;

FIG. 2a is a top view of the communication assembly of FIG. 1a;

FIG. 2b is a side view of the communication assembly of FIG. 1a;

FIG. 2c is a bottom view of the communication assembly of FIG. 1a;

FIG. 3a is a perspective front view of a communication assembly in accordance with another embodiment;

FIG. 3b is a perspective rear view of the communication assembly of FIG. 3a;

FIG. 3c is a cross-sectional view in a longitudinal direction of the communication assembly of FIG. 3a;

FIG. 3d is a front view of the communication assembly of FIG. 3a;

FIG. 3e is a rear view of the communication assembly of FIG. 3a;

FIG. 4a is a top view of the communication assembly of FIG. 3a;

FIG. 4b is a side view of the communication assembly of FIG. 3a;

FIG. 4c is a bottom view of the communication assembly of FIG. 3a;

FIG. 5a is a perspective front view of a communication assembly in accordance with another embodiment;

FIG. 5b is a perspective rear view of the communication assembly of FIG. 5a;

FIG. 5c is a cross-sectional view in a longitudinal direction of the communication assembly of FIG. 5a;

FIG. 5d is a front view of the communication assembly of FIG. 5a;

FIG. 5e is a rear view of the communication assembly of FIG. 5a;

FIG. 6a is a top view of the communication assembly of FIG. 5a;

FIG. 6b is a side view of the communication assembly of FIG. 5a;

FIG. 6c is a bottom view of the communication assembly of FIG. 5a;

FIG. 7 is a cross-sectional view in a longitudinal direction showing a communication system in accordance with an embodiment with mated connection components of a connection system suitable for transmission of power with voltage levels greater than or equal to 1 kV;

FIG. 8 is a perspective front view of a communication assembly in accordance with an embodiment; and

FIG. 9 is a front view of a connection component of a connection system suitable for transmission of power with voltage levels greater than or equal to 1 kV, the connection component being equipped with two communication assemblies provided in accordance with embodiments of the present invention.

### DETAILED DESCRIPTION

Embodiments described herein provide a communication assembly configured for use in a connection system suitable for transmission of power with voltage levels greater than or equal to 1 kV, the communication assembly being configured to provide a path for transmission of a communications signal via optical fibres. Embodiments further provide a communication system configured for use in a connection system suitable for transmission of power with voltage levels greater than or equal to 1 kV, the communication system comprising a pair of communication assemblies. Embodiments further provide a connection system suitable for transmission of power with voltage levels greater than or equal to 1 kV, the connection system comprising at least one electrical assembly for coupling to an electrical cable, the at least one electrical assembly being configured to provide a path for transmission of the power, and at least one communication assembly provided in accordance with embodiments.

The connection system suitable for transmission of power with voltage levels greater than or equal to 1 kV may be referred to in the following as high power electrical connection system, high power connection system, electrical connection system or simply connection system. The connection system is configured for connecting to electrical cables suitable for high power applications and comprises connection components that are arranged for coupling to each other. The connection components are suitable for transmission of power with voltage levels greater than or equal to 1 kV, and may be referred to in the following as high voltage (‘HV’) connection components, HV electrical connection components, HV electrical connectors, HV couplers, or simply electrical connectors or connection components. For example, the connection system may comprise first and second connection components arranged for coupling to each other. The first connection component may be a plug comprising pins and the second connection component may be a receptacle comprising sockets adapted for electrically connecting to the pins. The terms “connection components” and “connectors” are in the present specification used for any connection component or connector including, however not limited to, any one of a plug, a lug, an electrical adaptor, a plug coupler, or a receptacle.

Embodiments of the present invention may be suitable for various industrial applications including, however not limited to, the oil and gas industry, the mining industry, the renewable energy industry, general electrical power industry, HV portable generators, the maritime industry.

The connection system may be suitable for applications where the electrical cables are machine cables, such as a machine cables used for any machine, reeling or trailing cable arranged for delivery of power to mobile machinery such as large machinery in petroleum or mining industry.

Embodiments of the present invention aim at providing improved means for efficient and reliable transmission of communications signals in high power connection systems applications and environments, while providing a safe environment for workers or other persons present in the surroundings of high voltage connection systems.

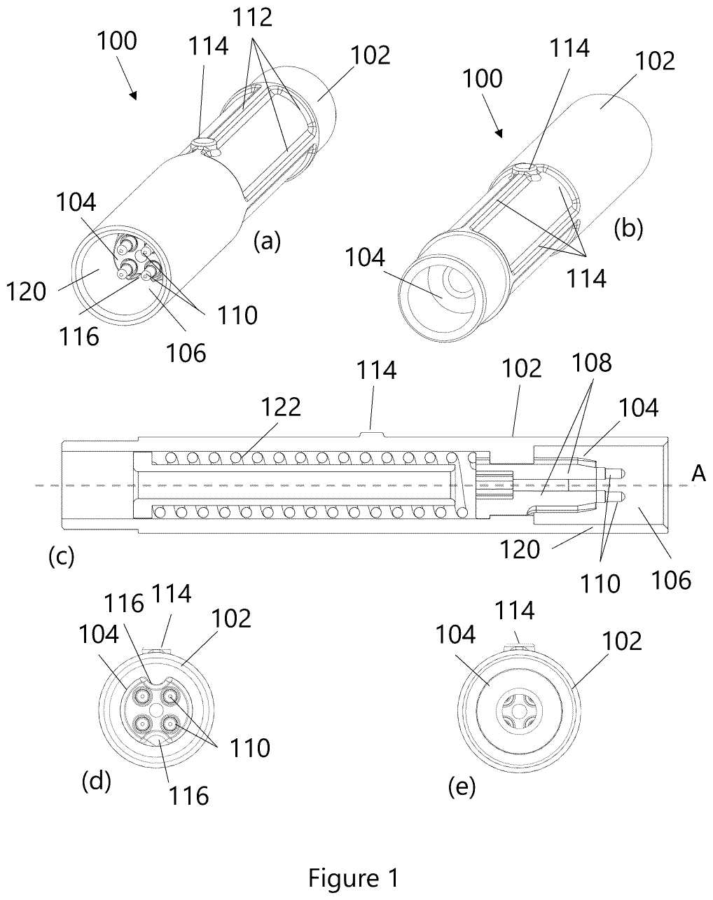

FIGS. 1 to 6 illustrate three different embodiments of a communication assembly 100, 200, and 300 configured for use in a connection system suitable for transmission of power with voltage levels greater than or equal to 1 kV. For example, the communication assemblies 100, 200, and 300 may be configured for use in restrained high power connection system or a bolted high power connection system, and may be configured for a connection component of the connection system, such as a plug, a receptacle, a back-to-back receptacle, a plug coupler, a lug, an electrical adaptor. Each communication assembly 100, 200, and 300 comprises an outer housing portion 102, 202, 302 configured to be mounted at a mounting location of the connection system (not shown in FIGS. 1 to 6). Each communication assembly 100, 200, 300 further comprises an inner portion 104, 204, 304 positioned, respectively, in the outer housing portion 102, 202, 302, the inner portion 104, 204, 304 comprising a connection end 106, 206, 306 and being configured to provide at least one path for transmission of a communications signal via optical fibres, the connection end 106, 206, 306 comprising at least one fibre optic connector 110, 210, 310. In the embodiments illustrated in FIGS. 1 to 6, each inner portion 104, 204, 304 comprising four fibre optic connectors 110, 210, 310 at the respective connection end 106, 206, 306, each inner portion 104, 204, 304 being configured to provide four corresponding paths for transmission of a communication signal via the fibre optic connectors 110, 210, 310. In the embodiments illustrated in FIGS. 1 to 6, each inner portion 104, 204, 304 further comprises fibre optic ferrule chambers 108, 208, 308 and inner portion 204, 304 comprises a chamber actuator 209, 309. The features 112, 212, 312 correspond to moulding features of the communication assembly designs.

It will be understood that embodiments of the present invention are not limited to such examples and that the inner portion of the communication assembly may be configured to provide any suitable number of fibre optic connectors, such as one, two, three or more than four, and any suitable corresponding number of paths for transmission of a communications signal. However, the number of fibre optic connectors and number of paths may be limited by the geometry and size of the communication assembly, such as the geometry and size of the inner portion.

In the illustrated examples, the inner portions 104, 204, 304 are dimensioned such that they can each accommodate four fibre optic connectors with, for example, each fibre optic connector having a diameter of 2 millimetres. However, it will be understood that embodiments of the present invention are not limited to such dimensions.

The outer housing portion 102, 202, 302 and the inner portion 104, 204, 304, have a generally substantially cylindrical shape. The outer housing portion 102, 202, 302 comprises an insulating material.

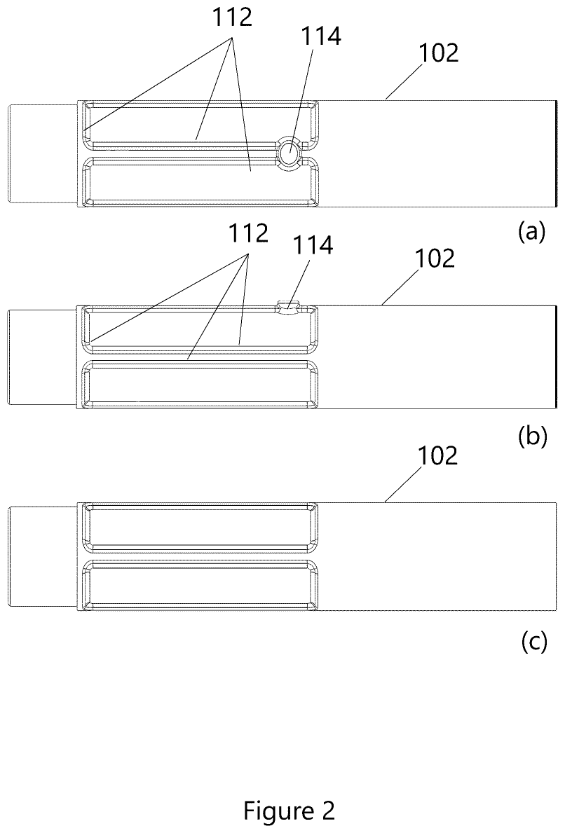

In one example, the communication assembly 100 illustrated in FIGS. 1a-1e and 2a-2c may be used in a connection component of a connection system, the connection component being provided as a plug (not shown).

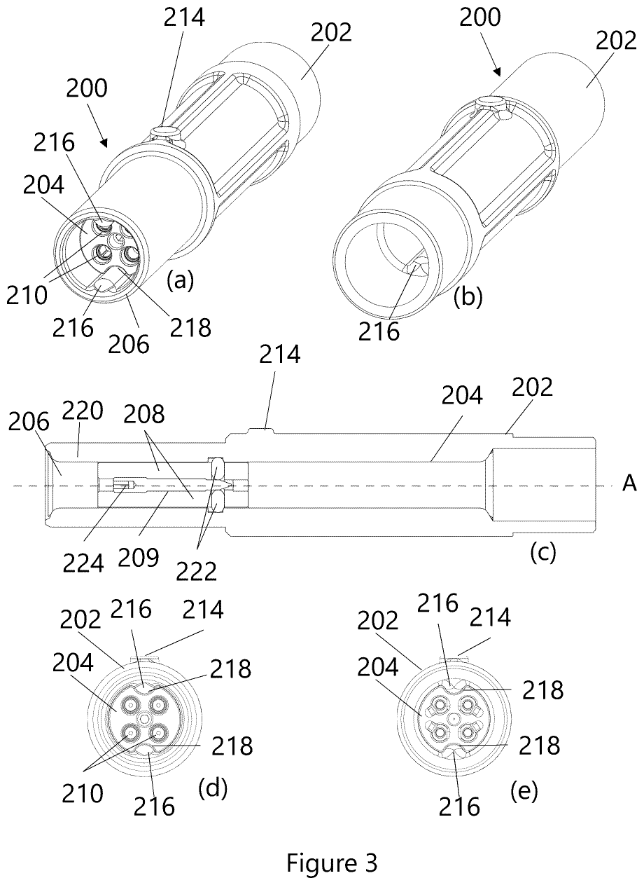

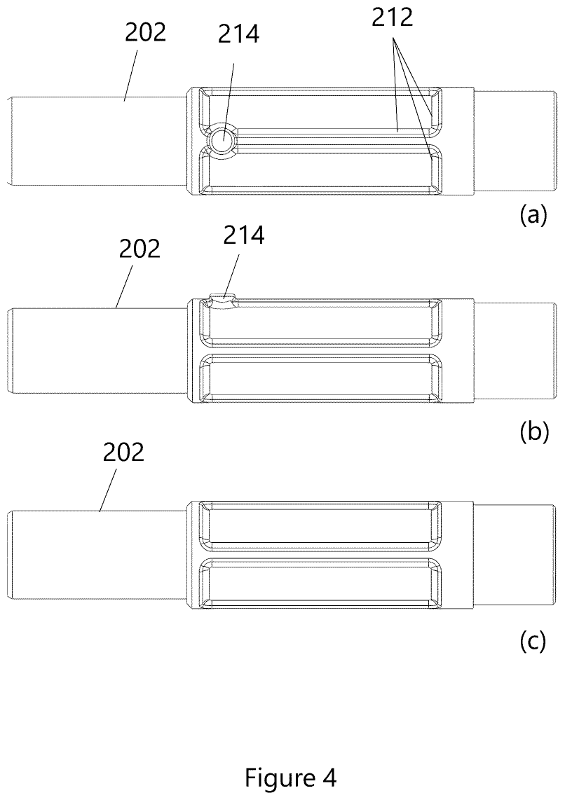

In another example, the communication assembly 200 illustrated in FIGS. 3a-3e and 4a-4c may be used in a connection component of a connection system, the connection component being provided as a receptacle (not shown).

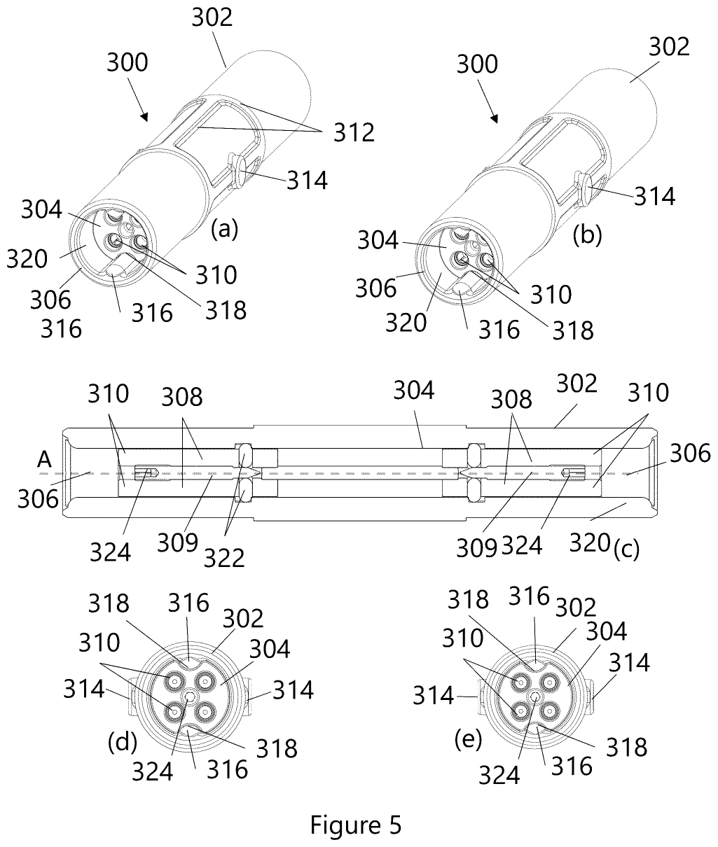

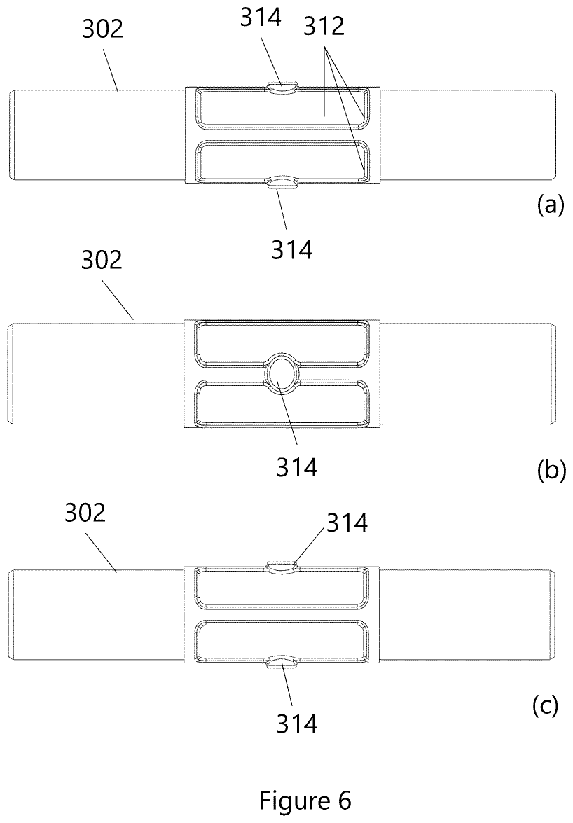

The communication assembly 300 illustrated in FIGS. 5a-5e and 6a-6c may be used in a connection component of a connection system, the connection component being provided as a back-to-back receptacle (not shown).

However, it will be understood that the communication assemblies may be used in any other suitable connection component of a high voltage connection system such as restrained and bolted connection components for restrained and bolted connection systems suitable for transmission of power with voltage levels <3.3 kV (restrained) and <33 kV (bolted).

In the particular example of a back-to-back receptacle, the communication assembly 300 comprises two opposite connection ends 306, each connection end 306 being configured to be coupled with a connection end of another mating communication assembly.

In these illustrated examples, the communication assembly 100 may be referred to as a male communication assembly 100, and the communication assemblies 200 and 300 may be referred to as female communication assemblies 200, 300. The male and female communications assemblies 100, 200, 300 are configured for positioning in respective opposite first and second connection components of the connection system, which may also be referred to as male and female connection components of the connection system. The male communication assembly 100 and female communication assemblies 200 or 300 in accordance with embodiments of the present invention are configured such that when the male communication assembly 100 is coupled to either one of the female communication assembly 200 and female communication assembly 300, a fibre optic connection is made for transmission of a communications signal via optical fibres.

The communication assembly in accordance with embodiments of the present invention are configured for use with single-mode optical fibres and multi-mode optical fibres.

The fibre optic connectors 110, 210, 310 are adapted for coupling to respective mating fibre optic connectors of another communication assembly to create a connection for transmission of a communications signal.

In the particular embodiments illustrated in FIGS. 1 to 6, the fibre optic connectors 110 may be referred to as male fibre optic connectors and are provided in the form of male fibre optic plugs 110. The fibre optic connectors 210 may be referred to as female fibre optic connectors and are provided in the form of female fibre optic sockets 210. Similarly, the fibre optic connectors 310 may be referred to as female fibre optic connectors and are provided in the form of female fibre optic sockets 310.

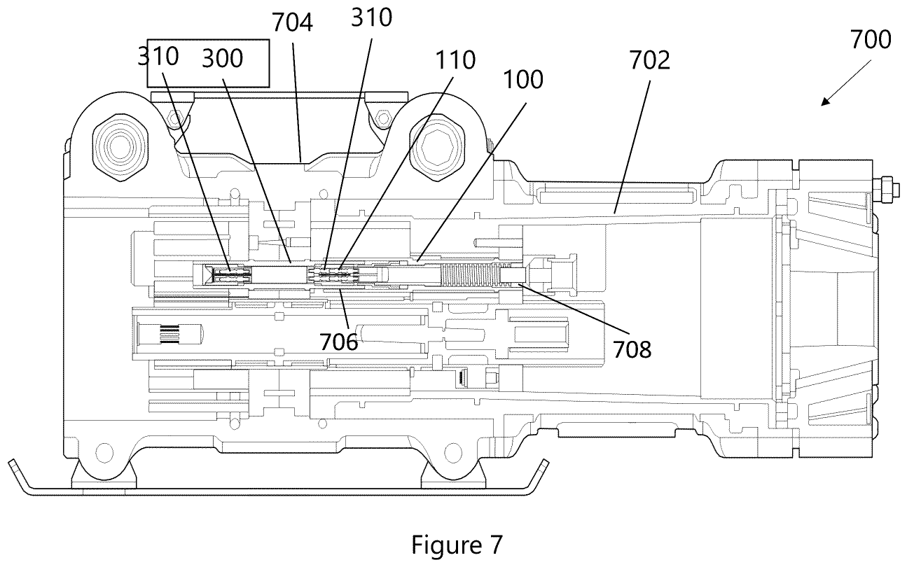

With reference to FIG. 7, in one embodiment, a pair of communication assemblies 100, 200, 300, more specifically a male communication assembly such as communication assembly 100, and a female communication assembly such as communication assembly 200 or 300, constitute elements of a communication system configured for use in a connection system suitable for transmission of power with voltage levels greater than or equal to 1 kV, such as connection system 700. The male communication assembly 100 and the female communication assembly 200, 300 can be coupled to each other to make a connection for transmission of a communications signal.

FIG. 7 is a cross-sectional view of a connection system 700 suitable for transmission of power with voltage levels greater than or equal to 1 kV, wherein male and female connection components of the connection system 700 are mated, i.e. electrically and mechanically coupled or engaged to each other. In this example, the male connection component 702 is provided in the form of a plug, and the female connection component 704 is provided in the form of a back-to-back receptacle. The plug 702 comprises male communication assembly 100, and the back-to-back receptacle 704 comprises female communication assembly 300. The male communication assembly 100 is shown coupled to the female communication assembly 300, with each male fibre optic connector 110 coupled to a respective female fibre optic connector 310.

Embodiments of the present invention aim to facilitate an automatic alignment and coupling of male and female fibre optic connectors, wherein a connection between male and female fibre optic connectors can be obtained in a substantially efficient and secure manner for an efficient and reliable transmission of a communications signal. Furthermore, the automatic alignment and coupling of male and female fibre optic connectors facilitate an automatic and secure mating of male and female communication assemblies when male and female connection components of the HV connection system are mated, which contributes to ensuring a safe environment for workers or other persons present in the surroundings of high voltage connection systems. The communication assembly provided in accordance with embodiments of the present invention positioned within connection components of HV connection systems are suitable for installation in environments where explosion-protected certification is required.

To facilitate an automatic alignment and coupling of male and female fibre optic connectors (which is very critical, in particular for use with single mode optical fibres), the communication assembly in accordance with an embodiment comprises an alignment system. This alignment system may comprise one or more alignment elements.

In one embodiment, the communication assembly 100 comprises a locating portion 114 at the outer surface of the outer housing portion 102. This locating portion 114 is configured to couple to a respective locating portion (not shown) of a connection component of the connection system, such as connection component 702. The locating portion 114 is provided in the form of a circumferential protrusion at the outer surface of the outer housing portion 102. The locating portion 114 is configured to be received by a mating circumferential groove located within the connection component (not shown). When the communication assembly 100 is mounted to the connection component 702, the locating portion 114 facilitates installation of the communication assembly at the nominated position within the connection component. The locating portion 114 also facilitates removal of the communication assembly 100 if required, such that damage to the communication assembly is substantially minimised. When the communication assembly 100 is mounted to the connection component 702, the locating portion 114 is received by a mating locating portion of the connection component such that the communication assembly is secured linearly relative to the connection component. The locating portion 114 however allows a degree of internal rotational movement of the communication assembly 100 relative to the connection component, which contributes to ensuring that respective male and female fibre optic connectors 110, and 210/310 are aligned prior to mating.

Similarly, the communication assembly 200 comprises a locating portion 214 at the outer surface of the outer housing portion 202. This locating portion 214 is configured to couple to a respective locating portion (not shown) of a connection component of the connection system. The locating portion 214 is provided in the form of a circumferential protrusion at the outer surface of the outer housing portion 202. The locating portion 214 is configured to be received by a mating circumferential groove located within the connection component (not shown). When the communication assembly 200 is mounted to the connection component, the locating portion 214 facilitates installation of the communication assembly at the nominated position within the connection component. The locating portion 214 also facilitates removal of the communication assembly 200 if required, such that damage to the communication assembly is substantially minimised. When the communication assembly 200 is mounted to the connection component 702, the locating portion 214 is received by a mating locating portion of the connection component such that the communication assembly is secured linearly relative to the connection component. Similarly, the locating portion 214 however allows a degree of internal rotational movement of the communication assembly 200 relative to the connection component, which contributes to ensuring that respective male and female fibre optic connectors 110, and 210/310 are aligned prior to mating.

The communication assembly 300 comprises locating portions 314 at the outer surface of the outer housing portion 302. The locating portions 314 are configured to couple to respective locating portions (not shown) of a connection component of the connection system, such as connection component 704 provided in the form of a back-to-back receptacle. The communication assembly 300 comprising two connection ends 306 suitable for mounting to a back-back receptacle, the locating portions 314 are provided in the form of circumferential protrusions located at opposite and symmetrical positions around the outer surface of the outer housing portion 302. The locating portions 314 are configured to be received by mating circumferential grooves located within the connection component (not shown). When the communication assembly 300 is mounted to the connection component, the locating portions 314 facilitate installation of the communication assembly at the nominated position within the connection component. The locating portions 314 also facilitate removal of the communication assembly 300 if required, such that damage to the communication assembly is substantially minimised. When the communication assembly 300 is mounted to the connection component 704, the locating portions 314 are received by mating locating portions of the connection component such that the communication assembly is secured linearly relative to the connection component. Similarly, the locating portions 314 however allow a degree of internal rotational movement of the communication assembly 300 around its axis relative to the connection component, which contributes to ensuring that respective male and female fibre optic connectors 110, and 210/310 are aligned prior to mating.

It will be understood that embodiments of the present invention are not limited to the above described locating portions, and that locating portions at the outer surface of the outer housing portion and mating locating portions within the connection component may be provided in any other suitable form to secure the communication assembly linearly relative to the connection component while allowing rotational movement of the communication assembly around its axis relative to the connection component. Furthermore, it will be understood that the locating portions at the outer surface of the outer housing portion may be suitable for connection components other than restrained devices which are a plug, a receptacle, and a back-to-back receptacle, and may for example, however not limited to, be suitable for a bolted plug, a plug coupler and an adaptor.

In one embodiment, the alignment system may further comprise one or more guiding portions configured to guide the alignment and coupling of the pair of communication assemblies (e.g., communication assembly 100 and communication assembly 200 or communication assembly 100 and communication assembly 300). The one or more guiding portions are configured to guide the alignment and coupling of the pair of communication assemblies in a manner such that respective opposite mating fibre optic connectors are aligned prior to being coupled and connected when the pair of communication assemblies are coupled to each other.

In a specific embodiment, with reference to FIGS. 1, 3 and 5, each of the communication assemblies 100, 200, 300 comprises one or more guiding portions, and the one or more guiding portions comprise protrusions and mating grooves that extend longitudinally along at least a portion of a length of the communication assembly 100, 200, 300.

More specifically, in one embodiment, the male communication unit 100 comprises two grooves 116 symmetrically and oppositely located around a circumference of the outer surface of the inner portion 104. In the present embodiment, the grooves 116 extend longitudinally along a length of the inner portion 104. However, it will be understood that embodiments are not limited to the grooves extending longitudinally along the length of the inner portion 104.

The female communication unit 200 comprises two protrusions 216 symmetrically and oppositely located around a circumference of the inner surface of the outer housing portion 202. In this embodiment, the protrusions 216 extend longitudinally along a portion of the length of the outer housing portion 202. The female communication unit 200 also comprises two grooves 218 symmetrically and oppositely located around a circumference of the outer surface of the inner portion 204, the grooves 218 extending longitudinally along a length of the inner portion 204. Each groove 218 is configured to mate a respective protrusion 216 such that the inner portion 204 and outer housing portion 202 are substantially fixed relative to each other.

The female communication unit 300 comprises two protrusions 316 symmetrically and oppositely located around a circumference of the inner surface of the outer housing portion 302. In this specific embodiment, as the female communication unit 300 is double-ended, i.e. comprises two connection ends 306, the protrusions 316 extend longitudinally along the entire length of the outer housing portion 202. The female communication unit 300 also comprises two grooves 318 symmetrically and oppositely located around a circumference of the outer surface of the inner portion 304, the grooves 318 extending longitudinally along a length of the inner portion 304. Each groove 318 is configured to mate a respective protrusion 316 such that the inner portion 304 and outer housing portion 302 are substantially fixed relative to each other.

With further reference to FIGS. 1, 3 and 5, in one embodiment, the outer housing portion 102, 202, 302, of each communication assembly 100, 200, 300 extends longitudinally beyond a length of the inner portion and beyond the fibre optic connectors 110, 210, 310, such that the fibre optic connectors 110, 210, 310 are surrounded by at least a portion 120, 220, 320 of the outer housing portion 102, 202, 302. In this embodiment, the protrusions 216, 316 extend beyond the fibre optic connectors 210, 310 at the connection end, and therefore extend along the portion 120, 220, 320. Further, the portion 220, 320, i.e. outer housing portion 202, 302 at the connection end 206, 306, is configured such that it can fit at least within portion 120, i.e. within the outer housing portion 102 at the connection end 106.

The portion of the protrusions 216, 316 at the connection end 206, 306 extending along the portion 220, 320 are configured to be coupled to the respective grooves 116 such that, when the male and female communication assemblies 100, 200, 300 are coupled, alignment of the communication assemblies and of the respective mating fibre optic connectors 110, 210, 310 occurs prior to the respective mating fibre optic connectors 110, 210, 310 being coupled and connected.

The male guiding portions and female guiding portions, or in this embodiment the protrusions 216 and mating grooves 116, are configured such that, when coupled, a rotational displacement of the male communication assembly relative and the female communication assembly relative to each other around a longitudinal axis A of the communication assemblies is allowed. In the illustrated embodiment, the protrusions 216 and mating grooves 116 comprise rounded edges, which contribute to affording the degree of freedom of rotation of the male and female communication assemblies relative to each other. The rotational displacement allowed to the male communication assembly and female communication assembly relative to each other as they are aligned and coupled is such that the angle of collinearity tolerance between the male and female communication assemblies as they are aligned and coupled is maximised.

In a connection system, wherein, for example, a plug is coupled to a back-to-back receptacle (e.g., connection system 700) or to a receptacle (another embodiment), the male communication assembly 100 may be coupled to either the female communication assembly 300 or the female communication assembly 200. When male and female connection component (plug and receptacle/back-to-back receptacle) are coupled, the male communication assembly 100 and the female communication assembly 200 or 300 come together with the male and female communication assemblies facing each other and coming into contact at their respective facing connection ends. Via the degree of rotational freedom afforded the male and female communication assemblies, the male and female communication assemblies are arranged to take a maximum angle of collinearity tolerance as they come and couple together. The portion 220, 320 then engages with the portion 120 and as the portion 220, 320 is pushed through the portion 120, front ends 220, 320 of the protrusions 216, 316 self-align and come into contact with respective front ends 120 of the grooves 116. This occurs prior to the male fibre optic connectors 110 coming into contact with the female fibre optic connectors 210, 310, such that damage to the fibre optic connectors 110, 210, 310 is substantially prevented. As the front ends 220, 320 self-align and come into contact with front ends 120, the portion of the protrusions 216, 316 are pushed through the grooves 116 and the fibre optic connectors 110, 210, 310 automatically align. Finally, as the connection components and communication assemblies 100, 200, 300 come together and are pushed towards each other, the fibre optic connectors 110, 210, 310 come together, are pushed together and coupled to each other to establish a connection for transmission of a communications signal via optical fibres.

In one embodiment, the male connection assembly 100 further comprises a resilient element 122 configured to be biased to secure and maintain engagement of the male and female fibre optic connectors 110, 210, 210 when the pair of communication assemblies 100, 200, 300 are coupled to each other. The resilient element 122 is provided in the form of a spring which is arranged such that, when biased, it applies constant force to the rear end 124 of the male communication assembly 100. As the constant force is applied to the rear end 124, engagement of the male fibre optic connectors 110 with the female fibre optic connectors 210, 310 can be facilitated and once engaged and mated, the connection between the male fibre optic connectors 110 and the female fibre optic connectors 210, 310 can be substantially maintained. Loss of connectivity between the male and female fibre optic connectors can be substantially avoided. The spring rate is a critical parameter as a spring rate that is too high can force the female fibre optic connectors 210, 310 out of the inner portion 204, 304. In one embodiment, a spring rate within the range 5 kgf to 10 kgf is envisaged.

It will be understood that embodiments of the present invention are not limited to the guiding portions above described being protrusions and mating grooves and may alternatively be provided in any other form suitable for guiding and allowing automatic alignment and coupling of the male and female communication assemblies and the male and female fibre optic connectors. Also, in embodiments where the guiding portions are provided as protrusions and mating grooves, it will be understood that the guiding portions are not limited to extending longitudinally along a portion or a length of the communication assembly, inner portion and/or outer housing portion. The guiding portions may be arranged or configured in any other suitable manner so as to provide guidance and facilitate alignment and coupling of the male and female fibre optic connectors.

It will be understood that embodiments of the present invention are not limited to the resilient member being a spring with a spring rate within a range 5 kgf to 10 kgf. The resilient member may be a spring having any other spring rate suitable for assisting in maintaining the connectivity between mated male and female fibre optic connectors. Alternatively, the communication assemblies and communication system may comprise any other suitable form of resilient element arranged to be biased to secure and maintain engagement of the male and female fibre optic connectors.

To further facilitate engagement of the male and female fibre optic connectors 110, 210, 310, and further secure and maintain connection of the male and female fibre optic connectors once mated, in one embodiment, the female communication assembly 200, 300, comprises a fastening element configured to restrict linear movement of the inner portion relative to the outer housing portion. The fastening element may be provided in the form of locking pins 222, 322, which limit the linear movement of the inner portion 204, 304 relative to the outer housing portion 202, 302.

In one embodiment, the female communication assembly 200 may further comprise a locking element 224 for securing the inner portion 204 in position relative to the outer housing portion 202. In one embodiment, the female communication assembly 300 may further comprise a locking element 324 at each connection end 306 for securing the inner portion 304 in position relative to the outer housing portion 302.

The combination of the resilient member at the male communication assembly 100 and the longitudinally fixed inner portion 204, 304 at the female communication assembly 200, 300 provides the following advantage. The resilient member 122 (e.g., spring) provides a positive engagement force and overcomes a resistance of the male fibre optic connectors 110 as they engage and couple to the female fibre optic connectors 210/310. Further the combination of these elements with the degree of relative rotational freedom afforded the male and female communication assemblies allows overcoming any colinear slack in the entire communication system engagement.

The fibre optic connectors 110, 210, 310 in accordance with embodiments of the present invention may be any fibre optic connector as may be considered suitable by a person skilled in the art.

The mating process during coupling of the male and female communication assemblies 100, 200, 300 as the male and female connection components of the connection system 700 are coupled may be further summarised as follows.

During mating of the whole plug to the whole receptacle/B2B, the communication assemblies 100, 200/300 will self-align. The communication assemblies 100, 200/300 come together and are designed to take a maximised angle of collinearity tolerance. Then, the guiding portions 216/316 of the female communication assembly 200/300 self-align with the matching guiding portions 116 of the male communication assembly 100. This is all done prior to the fibre optic connectors 110, 210/310 coming into contact thus preventing any damage to the fibre optic connectors. Finally, the mating fibre optic connectors 110, 210/310 are pushed together using the resilient member force to ensure the connection is made correctly between mating fibre optic connectors. At each stage of the mating process, the tolerance (float) of the male and female communication assemblies reduces so connectivity of the respective male and female fibre optic connectors is obtained at the end.

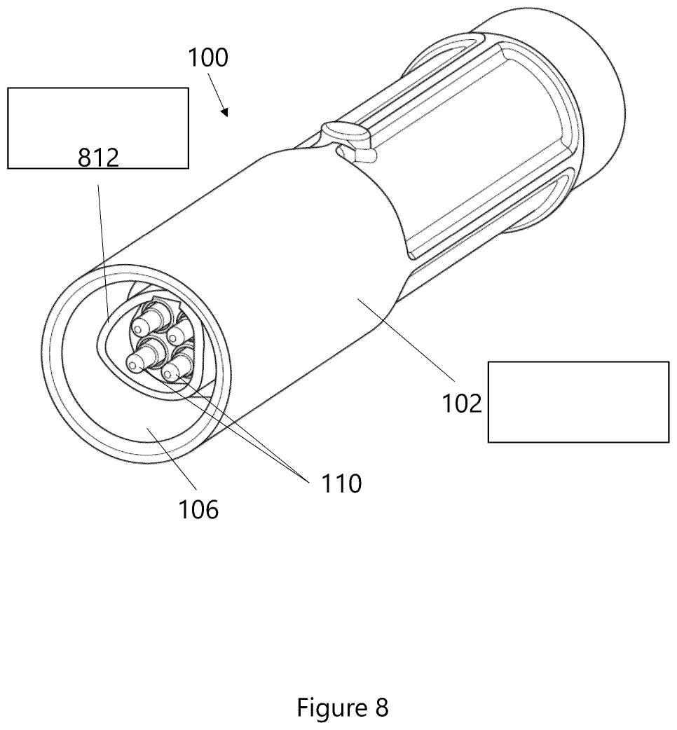

In another embodiment, with reference to FIG. 8, the alignment system may comprise, additionally or alternatively, a shroud portion 802 located at the connection end 106 of the communication assembly 100.

With further reference to FIG. 7, the communication assemblies 100 and 300 (or 200 in the embodiment wherein the connection component is a receptacle) may form isolated flameproof chambers when mated to each other. A front flame path 706 and a rear flame path 708 are provided within the communication system 700. These flameproof chambers and associated flame paths 706, 708, when formed, contribute to providing communication assemblies and a communication system that can be compliant with Ex d safety requirements if necessary, in particular for HV coupler or connection systems used in Ex applications in an associated environment in which the HV connection system is to be installed. The communication assemblies and communication system in accordance with some embodiments of the present invention may thus be used in explosion protected equipment while maintaining Ex d flameproof safety requirements when installed in a connection system suitable for transmission of power with voltage levels greater than or equal to 1 kV.

The communication units and communication system provided in accordance with embodiments of the present invention provide additional safety and contribute to minimising the risk of explosion by allowing isolation from low voltage in the connection system (due to the transmission of light rather than electricity).

Embodiments of the present invention provide an improved means for efficient and reliable transmission of communications signals in high power connection systems applications and environments, while providing a safe environment for workers or other persons present in the surroundings of high voltage connection systems. Embodiments of the present invention provide an improved means for transfer of communications in a high voltage environment wherein workers may be able to receive feedback in real or near-real time and the ability to remove workers and other persons from hazardous areas may be substantially increased.

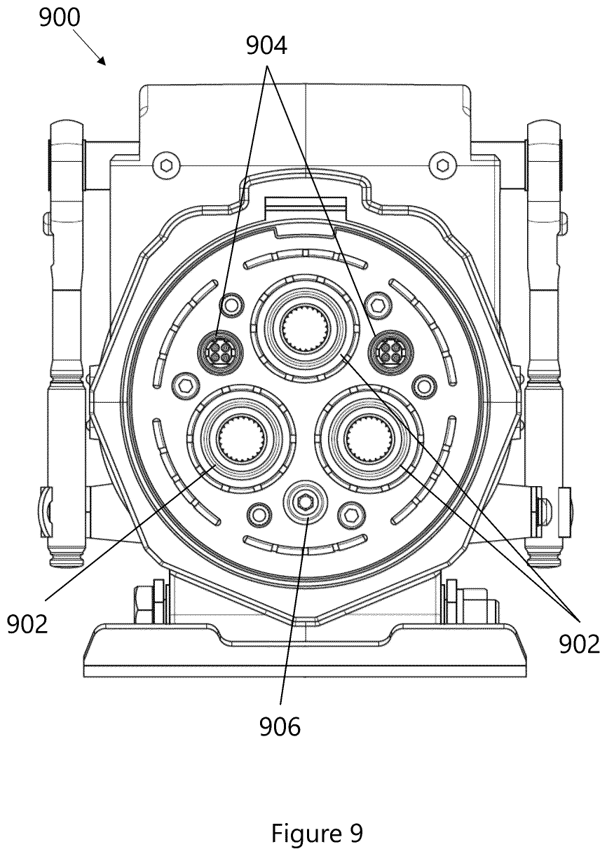

With reference to FIG. 9, there is shown a front view of a connection component 900 in accordance with an embodiment, configured for use in a connection system suitable for transmission of power with voltage levels greater than or equal to 1 kV, such as connection system 700. The connection component 900 may be any of a plug, a receptacle, a back-to-back receptacle, a plug coupler, a lug, an electrical adaptor. In the present specific embodiment, the connection component 900 comprises three electrical assemblies 902 for coupling to an electrical cable (not shown), each electrical assembly 902 being configured to provide a path for transmission of the power. The connection component 900 further comprises two communication assemblies 904 provided in accordance with embodiments of the present invention (such as, for example, communication assembly 100 if the connection component is a plug or communication assembly 200 if the connection component is a receptacle, or communication assembly 300 if the connection component is a back-to-back receptacle). In the embodiment illustrated, the connection component 900 also comprises one metallic (metalliferous) assembly 906 (which may comprise, for example however not limited to, Copper, Brass, Aluminium) configured for transmission of an electrical signal. It will be understood that it is further envisaged that the connection component 900 comprises at least one communication assembly provided in accordance with embodiments of the present invention and may comprise three or more communication assemblies provided in accordance with embodiments of the present invention. It will be understood that the geometrical arrangement and number of communication assemblies within the connection component may vary and may be limited by the geometry of the connection component. The communication assembly provided in accordance with embodiments of the present invention is modular and presents the advantage that it can be adapted for integration in various types of connection components. Further, the communication assembly allows for replacing existing Copper internal connections in connection components to fibre optic connections. The connection components and connection system may be configured with different auxiliary communication assemblies, including both metallic or metalliferous assemblies and fibre optic communication assemblies instead of all metallic assemblies. This assists in improving efficiency and reliability of transmission of communications signals in high power connection systems applications and environments, but also in reducing the risk typically associated with low voltage being present in the vicinity of metallic assemblies.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features in various embodiments of the invention.

Modifications and variations as would be apparent to a skilled addressee are determined to be within the scope of the present invention.

1. A communication assembly configured for use in a connection system suitable for transmission of power with voltage levels greater than or equal to 1 kV, the communications assembly comprising:
an outer housing portion configured to be mounted at a mounting location of the connection system; and
an inner portion positioned in the outer housing portion, the inner portion comprising a connection end and being configured to provide at least one path for transmission of a communications signal, the connection end comprising at least one fibre optic connector.

2. The communication assembly of claim 1, wherein the at least one fibre optic connector is adapted for coupling to a respective mating fibre optic connector of another communication assembly to create a connection for transmission of a communications signal.

3. The communication assembly of claim 1, wherein the connection end comprises at least two fibre optic connectors.

4. The communication assembly of claim 1, wherein the outer housing portion and the inner portion have a substantially cylindrical shape.

5. The communication assembly of claim 1, wherein the outer housing portion comprises an insulating material.

6. The communication assembly of claim 1, further comprising a resilient element configured to be biased to secure and maintain engagement of mating fibre optic connectors when the communication assembly is coupled to another communication assembly.

7. The communication assembly of claim 6, wherein the resilient element is configured such that, when biased, it applies constant force to a rear end of the communication assembly.

8. The communication assembly of claim 6, wherein the resilient element is a spring having a spring rate within the range 5 kgf to 10 kgf.

9. The communication assembly of claim 1, wherein the inner portion comprises two opposite connection ends, each connection end comprising at least one fibre optic connector.

10. The communication assembly of claim 9, wherein each connection end comprises at least two fibre optic connectors.

11. The communication assembly of claim 1, further comprising an alignment system for facilitating alignment and coupling of each fibre connector with a respective mating fibre optic connector of another mating communication assembly.

12. The communication assembly of claim 11, wherein the alignment system comprises one or more guiding portions configured to guide the alignment and coupling of the communication assembly with another mating communication assembly.

13. The communication assembly of claim 12, wherein, when the communication assembly is coupled to the other mating communication assembly, the one or more guiding portions are configured to interlock with one or more mating guiding portions of the other mating communication assembly in a manner such that a rotational displacement of the communication assembly relative to the other mating communication assembly is allowed.

14. The communication assembly of claim 12, wherein the one or more guiding portions extend along at least a portion of a length of the communication assembly.

15. The communication assembly of claim 1, wherein the one or more guiding portions comprise one or more guiding portions located at the connection end.

16. The communication assembly of claim 1, wherein the one or more guiding portions comprise one or more protrusions and/or one or more mating grooves, the protrusion and mating grooves extending longitudinally along at least a portion of a length of the communication assembly.

17. The communication assembly of claim 1, wherein the one or more guiding portions comprise rounded edges.

18. The communication assembly of claim 1, wherein, the one or more guiding portions are configured such that, when the communication assembly is coupled to the other mating communication assembly, the one or more guiding portions interlock with the one or more mating guiding portions of the other mating communication assembly prior to respective opposite mating fibre optic connectors being coupled and connected to each other.

19. The communication assembly of claim 1, wherein the one or more guiding portions comprise a shroud portion located at the connection end of the communication assembly.

20. The communication assembly of claim 1, wherein the inner portion is fixed in a longitudinal direction relative to the outer housing portion.

21.-56 (canceled)

57. The communication assembly of claim 20, wherein the communication assembly comprises a fastening element configured to restrict linear movement of the inner portion relative to the outer housing portion.

58. The communication assembly of claim 11, wherein the alignment system comprises at least one locating portion at the outer surface of the outer housing portion, the at least one locating portion being configured to couple to a respective locating portion of a connection component of the connection system, whereby the communication assembly is substantially secured to the connection component when the communication assembly is mounted at a location of the connection component.

59. The communication assembly of claim 11, wherein the alignment system is configured such that, when the communication assembly is coupled to another communication assembly, a maximised angle of collinearity tolerance between the mated communication assemblies is allowed.

60. The communication assembly of claim 1, wherein the at least one path and at least one fibre optic connector are configured for use with any one of a single-mode optical fibre element or a multi-mode optical fibre element.

61. A communication system configured for use in a connection system suitable for transmission of power with voltage levels greater than or equal to 1 kV, the communication system comprising a pair of communication assemblies that are configured to provide at least one path for transmission of a communications signal and such that they can be coupled to each other to make a connection for transmission of a communications signal.

62. The communication system of claim 61, wherein the pair of communication assemblies comprises a male communication assembly and a female communication assembly, the male communication assembly and the female communication assembly being configured for mounting at a respective location of respective first and second components of the connection system.

63. The communication system of claim 62, wherein each of the male communication assembly and the female communication assembly comprises:
an outer housing portion configured to be mounted at a mounting location of a respective component of the connection system; and
an inner portion positioned in the outer housing portion, the inner portion comprising a connection end and being configured to provide at least one path for transmission of a communications signal, the connection end comprising at least one fibre optic connector, each fibre optic connector of the male communication assembly being adapted for coupling to a respective mating fibre optic connector of the female communication assembly to create a connection for transmission of a communication signal.

64. The communication system of claim 63, wherein the outer housing portion and the inner portion have a substantially cylindrical shape.

65. The communication system of claim 63, comprising an alignment system for facilitating alignment and coupling of respective opposite mating fibre optic connectors when the pair of communication assemblies are coupled to each other.

66. The communication system of claim 65, wherein the alignment system comprises one or more guiding portions configured to guide the alignment and coupling of the pair of communication assemblies.

67. The communication system of claim 66, wherein the one or more guiding portions are configured to guide the alignment and coupling of the pair of communication assemblies in a manner such that respective opposite mating fibre optic connectors are aligned prior to being coupled and connected when the pair of communication assemblies are coupled to each other.

68. The communication system of claim 66, wherein each of the male and female communication assemblies comprises one or more respective male and female guiding portions.

69. The communication system of claim 68, wherein male guiding portions of the male communication assembly are configured to be coupled to respective female guiding portions of the female communication assembly in a manner such that, when coupled, a rotational displacement of the male communication assembly and the female communication assembly relative to each other around a longitudinal axis of the communication assemblies is allowed.

70. The communication system of claim 66, wherein the one or more guiding portions extend along at least a portion of a length of the communication assembly.

71. The communication system of claim 66, wherein the one or more guiding portions comprise one or more protrusions and one or more respective mating grooves, the protrusion and mating groove extending longitudinally along at least a portion of a length of the communication assembly.

72. The communication system of claim 65, wherein, when the male and female communication assemblies are coupled, the one or more male guiding portions interlock with the one or more female guiding portions prior to respective male and female fibre optic connectors being coupled and connected to each other.

73. The communication system of claim 66, wherein the one or more guiding portions comprise rounded edges.

74. The communication system of claim 66, wherein the one or more guiding portions comprise a shroud portion located at the connection end of at least one of the male and female communication assemblies.

75. The communication system of claim 66, wherein the inner portion of at least one of the communication assemblies is fixed in a longitudinal direction relative to the outer housing portion.

76. The communication system of claim 75, wherein the at least one of the communication assemblies comprises a fastening element configured to restrict linear movement of the inner portion relative to the outer housing portion.

77. The communication system of claim 61, wherein at least one of the communication assemblies comprises a resilient element configured to be biased to secure and maintain engagement of the male and female fibre optic connectors when the pair of communication assemblies are coupled to each other.

78. The communication system of claim 77, wherein the resilient element is configured such that, when biased, it applies constant force to a rear end of the at least one of the communication assemblies.

79. The communication system of claim 77, wherein the resilient element is a spring having a spring rate within the range 5 kgf to 10 kgf.

80. The communication system of claim 65, wherein the alignment system is configured such that, when the male and female communication assemblies are coupled, a maximised angle of collinearity between the mated communication assemblies is allowed.

81. The communication system of claim 61, wherein the communication assemblies form isolated flameproof chambers when mated to each other.

82. The communication system of claim 81, wherein the communication assemblies, when mated to each other, define front and rear flame paths.

83. The communications system of claim 63, wherein the inner portion of at least one of the pair of communication assemblies comprises two opposite connection ends, each connection end comprising at least one fibre optic connector.

84. The communication system of claim 83, wherein each connection end comprises at least two fibre optic connectors.

85. The communication system of claim 83, wherein the outer housing portion comprises an insulating material.

86. The communication system of claim 83, wherein the at least one path and at least one fibre optic connector are configured for use with any one of a single-mode optical fibre element or a multi-mode optical fibre element.

87. The communication system of claim 62, wherein the first component is a plug arranged for engagement, mechanically and electrically coupling with the second component.

88. The communication system of claim 62, wherein the second component is one of a receptacle and a back-to-back receptacle.

89. The communication system of claim 62, wherein the first component is a plug coupler.

90. The communication system of claim 62, wherein the second component is an electrical adaptor.

91. A connection component configured for use in a connection system suitable for transmission of power with voltage levels greater than or equal to 1 kV, the connection component comprising:
at least one electrical assembly for coupling to an electrical cable, the at least one electrical assembly being configured to provide a path for transmission of the power; and

92. The connection component of claim 55, comprising at least two communication assemblies, each communication assembly being in accordance with claim 1.
